(19) United States
(12) Patent Application Publication
(10) Pub. No.: US 2017/0337516 A1
(43) Pub. Date: Nov. 23, 2017

(54) DISTRIBUTED PRODUCT DEVELOPMENT AND FUNDING SYSTEM

(71) Applicant: KUIU, Inc., Dixon, CA (US)

(72) Inventors: Jason Hairston, Dixon, CA (US); Adam Hairston, Garden City, ID (US)

(73) Assignee: KUIU, Inc., Dixon, CA (US)

(21) Appl. No.: 15/158,378

(22) Filed: May 18, 2016

(51) Int. Cl. G06Q 10/10; G06F 3/0484; G06T 11/00; G06Q 30/02; G06T 11/60

(52) U.S. Cl. CPC G06Q 10/101; G06Q 30/0202; G06T 11/60; G06T 11/001; G06F 3/04847; G06Q 30/0283; G06Q 30/0279; G06T 2200/24; G06Q 2230/00

(57) ABSTRACT

Technologies for distributed gear development is shown. Users generate proposed products through a development process based on project data. A community of users may provide feedback about the plurality of proposed products in a particular project. Conditional funding may be received from the users as a pre-purchase of a proposed product. A subset of the plurality of proposed projects may be selected for production.

### TECHNICAL FIELD

The present disclosure relates generally to systems and methods to provide distributed development tools to users.

### BACKGROUND

A challenge of many businesses is maintaining cash flow and financing the day-to-day operations of the business. In many industries there is a lag time between when a business must invest capital in a product or service and when the business gets paid for that product or service. For example, in the hunting industry, a business typically must spend money designing and producing hunting apparel long before the product finds its way to the shelves and the business can realize any revenue or profits from the product. If the new product fails to become a commercial success, the business loses its initial investment in the product. To reduce this financial risk, businesses may turn to a number of financing methods to keep themselves afloat during the lag time between investment and returns. For example, businesses may take out loans, issue stock, attract an angel investor, engage in factoring, or turn to other individuals for funding.

Another way businesses attempt to offset the risk of their initial investment is by seeking consumer input on product development, such as through studies, surveys, focus groups, or other means. Despite their best efforts, many businesses find that such consumer input can be a poor predictor of future consumer behavior. In addition, the manner in which the content is presented may bias the results. At the same time, consumers frequently recognize problems and develop solutions to those problems at the outset of a product design process—long before a business may recognize those same problems. Most consumers lack, however, the know-how, capital, or connections to realize their solutions either through making the product themselves or by connecting with a business that can make the product.

There is a need, therefore, to merge the objective of niche industry product development financing with the product development itself.

### SUMMARY

One aspect of the present disclosure relates to a method of distributed product development. The method may include outputting project data indicative of a product under development to a user, the project data including fixed feature data indicative of one of more fixed features of the product under development that are not changeable by the user and optional feature data indicative of one or more optional features of the product under development that are changeable by the user, receiving user preference data indicative of one or more optional features to include in a proposed product, generating proposed product data based at least in part on the project data and the user preference data, the proposed product data including the fixed feature data and a subset of the optional feature data indicated by the user preference data, generating an image of the proposed product based at least in part on the proposed product data, the image showing the features of the proposed product including the fixed features and the one or more optional features included in the user preference data, and outputting the image to the user.

The method may also include generating the image by layering one or more feature images together. The method may also include selecting the one or more feature images from a feature image database based at least in part on the proposed product data. The image may be generated immediately upon receiving user preference data.

The method may also include determining that the proposed product is ready to be reviewed by other users. The method may also include outputting the image to the plurality of users prior to receiving user feedback data, and receiving a plurality of votes from the plurality of users, the votes being used to determine which proposed product of the project will be produced. The method may also include determining whether the proposed product will be produced based at least in part on feedback data received from a plurality of users. The method may also include receiving conditional funding data indicative of conditional funding received for producing the proposed product, wherein the conditional funding may be returned to the user if the proposed product is not produced. The image may show fixed features and optional features that are visually apparent to the user in a final product.

Another aspect of the present disclosure relates to a method of distributed product development. The method may include outputting project data indicative of a product under development to a user, the project data including fixed feature data indicative of one of more fixed features of the product under development that are not changeable by the user and optional feature data indicative of one or more optional features of the product under development that are changeable by the user, receiving user preference data indicative of one or more optional features to include in a proposed product, generating proposed product data based at least in part on the project data and the user preference data, the proposed product data including the fixed feature data and a subset of the optional feature data indicated by the user preference data, receiving conditional funding data indicative of conditional funding received for producing the proposed product, wherein the conditional funding may be returned to the user if the proposed product is not produced, and determining whether the proposed product will be produced based at least in part on feedback data received from a plurality of users.

The method may also include receiving a plurality of proposed products developed from the project data, each of the proposed products having associated proposed product data, and grouping the plurality of proposed products into unique proposed products, wherein the proposed product data for each unique proposed product is different than the proposed product data for other unique proposed products. Each unique proposed product may include a combination of optional features that is unique from combinations of optional features of the other unique proposed products. Grouping the proposed products may include comparing the proposed product data against a database of stored proposed product data, and determining whether the proposed product data is already stored on the database. The method may also include selecting at least one of the proposed products of the plurality of proposed products to produce based at least in part on the feedback data from the plurality of users. The feedback data may include votes for one or more of the plurality of proposed products. The conditional funding data further indicates an escrow account that the conditional funding be placed into until it is determined whether the proposed product will be produced. The conditional funding may be at least equal to a cost of the proposed product, the cost of the proposed product being a sum of a cost of each fixed feature and a cost of the one or more optional features included in the user preference data. The project data may include pricing data for each feature of the product under development such that each fixed feature may have fixed pricing data and each optional feature may have optional pricing data.

The method may also include setting a new proposed price after a time threshold has been surpassed. The method may also include generating an image of the proposed product using the proposed product data, and outputting the image to the user to allow the user to review one of more optional features selected as part of the user preference data. Receiving conditional funding data further may include receiving conditional funding for a proposed product that was generated from a different user's user preference data. The project data, the user preference data, the proposed product data, the feedback data, or the funding data may be stored on a gear development database. The project data may include a funding goal indicative of how much money a project creator request to produce the proposed product.

Another aspect of the present disclosure relates to a method of predicting future sales. The method may include receiving user preference data, user feedback data, and conditional funding data as part of a product development process, generating development data indicative of the product development process performed by the plurality of users using project data, feedback data indicative of preferences of the plurality of users after reviewing a plurality of proposed products developed from a project, and funding data indicative of conditional funding pledged to the proposed products, and generating a sales prediction parameter indicative of a prediction of future sales for each proposed product of the plurality of proposed products, each sales prediction parameter based at least in part on the development data, the feedback data, and the funding data associated with its respective proposed product.

The method may also include predicting future sales of the proposed product based at least in part on convergence data indicative of how many proposed products converged on a similar set of features, votes cast in favor of producing the proposed product, or a speed with which the proposed product was funded using conditional funding. The sales prediction parameter may include a mass-production prediction parameter indicative of likely future sales if the proposed product were mass-produced and sold in stores and a direct-to-consumer prediction parameter indicative of likely future sales if the proposed product were sold directly to users. The development data may include proposed product data generated by the plurality of users, convergence data indicative of whether the product development process converged on a few recurring proposed products, a number of times any given proposed product of the plurality of proposed products was generated, or a development time parameter indicative of an amount of time users took to develop proposed products. The feedback data may include voting data generated by the plurality of users after reviewing one or more proposed products and comment data received regarding each proposed product. The funding data may include an amount of money raised in conditional funding for the proposed product, how fast a project reaches its conditional funding goals, and a profit margin associated with the proposed product. The sales prediction parameter may be based at least in part on fabrication data.

### BRIEF DESCRIPTION OF THE DRAWINGS

A further understanding of the nature and advantages of the embodiments may be realized by reference to the following drawings. In the appended figures, similar components or features may have the same reference label.

FIG. 1 is a simplified block diagram of an embodiment of a distributed gear development and funding system.

FIG. 2 is a simplified block diagram of a plurality of computing devices of the distributed gear development and funding system of FIG. 1.

FIG. 3 is a simplified block diagram of an embodiment of a computing environment executed on one of the computing devices of FIG. 2.

FIG. 4 is a simplified flow diagram of an embodiment of a method of developing gear using the distributed gear development and funding system of FIG. 1.

FIG. 5 is a simplified flow diagram of an embodiment of a method of generating a proposed product as part of a project and outputting images of the proposed product using the system of FIG. 1.

FIG. 6 is a simplified flow diagram of an embodiment of a method of generating sales prediction parameters.

FIG. 7 is a simplified graphical representation of a user process of selecting a project from a plurality of projects.

FIG. 8 is a simplified graphical representation of a user process for selecting optional features of a proposed product.

FIG. 9 is a simplified graphical representation of a user process for selecting optional features of a proposed product.

FIG. 10 is a simplified graphical representation of a user process of reviewing funding of a project.

FIG. 11 is a simplified graphical representation of a project creator process for determining pre-purchase promotions.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure is generally directed toward technologies for providing distributed product development and funding, which connects businesses offering new products with consumers. In many markets, there often exists groups of passionate consumers who are heavily invested in the market and can provide substantial amounts of know-how and feedback to a business offering products to that same market. For example, there is a large contingent of passionate outdoor and hunting enthusiasts who are heavily invested in the outdoor and hunting market. The technologies described herein allow project creators (i.e., businesses) to crowdsource decisions about their future products to these consumer enthusiasts. This moves the consumer one step closer to production, and further mitigates the risks businesses take to develop and produce a new product.

In addition, the technologies described herein allow the participating consumers to invest financially in the products they help develop. In this way, the business can offset their financial risk for producing the product and the consumer has a sense of ownership and purpose for the project. The development process, the crowdsourcing process, and the funding process, described herein will also supply additional data to project creators so they better understand the demographics behind the demand for their products. The technologies described herein combine consumer product development (e.g., voting on features and product design features) with direct consumer funding and provides a platform for meaningful interactions between consumers purchasing products and the businesses that make those products.

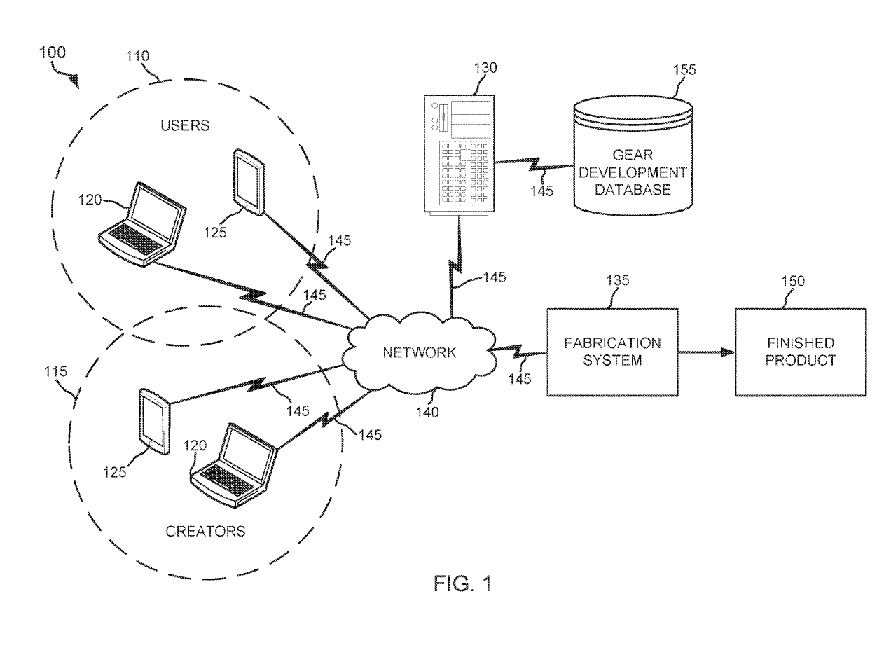

FIG. 1 shows an example of a distributed product (e.g., gear development) system 100 that incorporates at least some of the features described above. The distributed product or gear development system 100 connects a plurality of users 110 with the a plurality of project creators 115 to engage in a collaborative effort of product development and direct consumer funding. The distributed gear development system includes a plurality of local computing devices 120, 125 utilized by both the users 110 and the project creators 115 connected to one or more servers 130 and a fabrication system 135 through a network 140. While the users 110 and the project creators 115 in FIG. 1 show two local computing devices 120, 125 in their respective groups, this is only for illustrative purposes. The distributed gear development system 100 may support any number of users 110, any number of project creators 115, and any number of local computing devices 120, 125 in those respective groups. As shown in FIG. 1, in some embodiments, a project creator 115 may also be one of the users 110. In other embodiments, the project creators 115 are not one of the users 110. In some embodiments, project creators 115 must be approved by one or more operators of the distributed gear development system 100 before they can create a project.

The network 140 may be a wired or wireless network, or any combination thereof. For example, the network may be embodied as Ethernet, Wi-Fi, cellular, LTE, Bluetooth, local area network, public network, optical network, the Internet, and/or any other type of network. The network 140 may include more than one type of connection (e.g., wired and wireless connections) in a single implementation. Each of the local computing devices 120, 125, the server(s) 130, and the fabrication system 135 are connected to the network 140 through network connections 145, which may be wired connections or wireless connections based on the type of network being employed by each individual computing device. The server(s) 130 may also be connected via a network connection 145 to a gear development database 155 configured to store data related to the distributed gear development system 100. In some embodiments, the gear development database 155 may be connected directly to the network 140, and the server(s) 130 may access the database 155 via the network 140. In some embodiments, the gear development database 155 may execute or use the exemplary database schema attached to this patent application as Exhibit A, which is incorporated in its entirety by this reference.

As will be described in more detail hereafter, after a collaborative enterprise between users 110 and project creators 115, proposed new products will be approved for production. At such a time, the selected proposed product is sent to the fabrication system 135 to be fabricated into a finished product 150. The fabrication system 135 may be embodied as any number of systems designed to implement a variety manufacturing techniques, based on the type of product being produced. For example, the finished product 150 may include apparel, hunting equipment, electronics, or other types of consumer goods. As a result, the fabrication system 135 may employ many types of fabrication techniques. For example, types of manufacturing techniques may include casting, molding, forming, additive manufacturing (such as three-dimensional printing), machining, welding, sewing, and/or other techniques for manufacturing. In some embodiments, the fabrication system 125 is operated by a third-party, which does not operate the distributed gear development system 100, such as an independent manufacturing company.

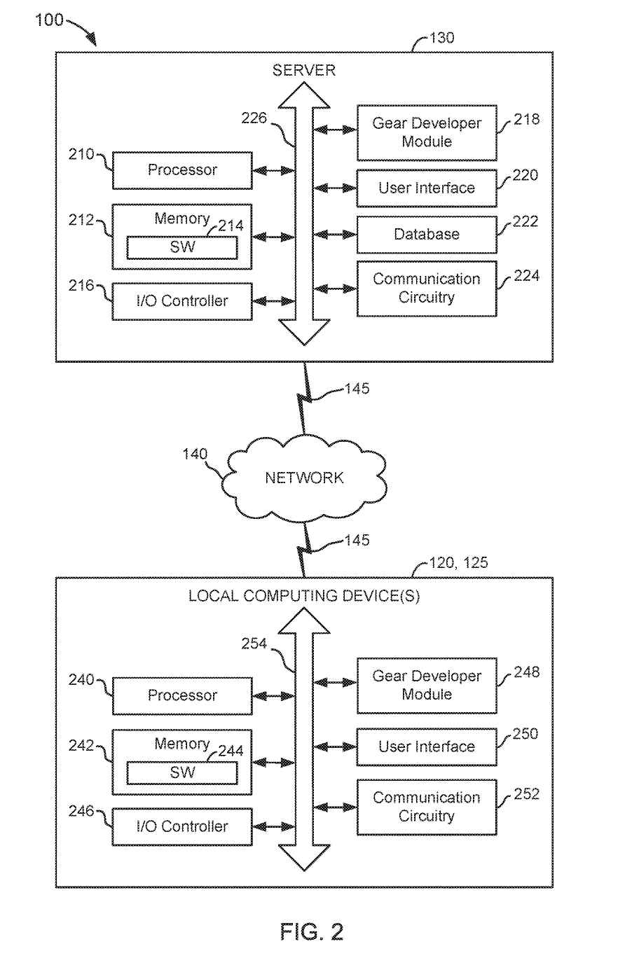

FIG. 2 shows examples of hardware implementations of local computing devices 120, 125 and server(s) 130 for use with the distributed gear development system 100. The server 130 may be embodied as any type of computing device capable of performing the functions described herein, and may be embodied as a server, a database, a personal computer, a laptop, a smartphone, a tablet, another handheld device, or any other type of computing device.

The server 130 illustratively includes a processor 210, memory, 212, an Input/Output controller (I/O controller) 216, a gear developer module 218, a user interface 220, a database 222, and communication circuitry 224. One or more busses 226 facilitate communication between one or more elements of the server 130 (e.g., the processor 210, the memory 212, the I/O controller 216, the gear developer module 218, etc.). While the server 130 is shown as a single unit, the elements and functions of the server 130 may be distributed across multiple devices working together.

The processor 210 may be embodied as any processor configured to perform the functions described herein (e.g., a controller, microprocessor, microcontroller, digital signal processor, etc.). The processor 210 may include an intelligent hardware device, e.g., a central processing unit (CPU), a microcontroller, an application-specific integrated circuit (ASIC), etc. The processor 210 is configured to execute a plurality of instructions based on the commands of the gear developer module 218, 248.

The memory 212 may include random access memory (RAM), read only memory (ROM), flash RAM, and/or other types. The memory 212 may store computer-readable, computer-executable software/firmware code 214 including instructions that, when executed, cause the processor 210 to perform various functions described in this disclosure (e.g., generating images of proposed products, generating proposed products based on user preference data, managing financial accounts of conditional funding, generating parameters indicative of future sales of a proposed product, and managing user feedback).

Although not specifically shown, it should be understood that the I/O controller 216 typically includes, among other things, one or more I/O ports and a memory controller. The I/O controller 216 is communicatively coupled to a number of components, including the processor 210 and memory 212.

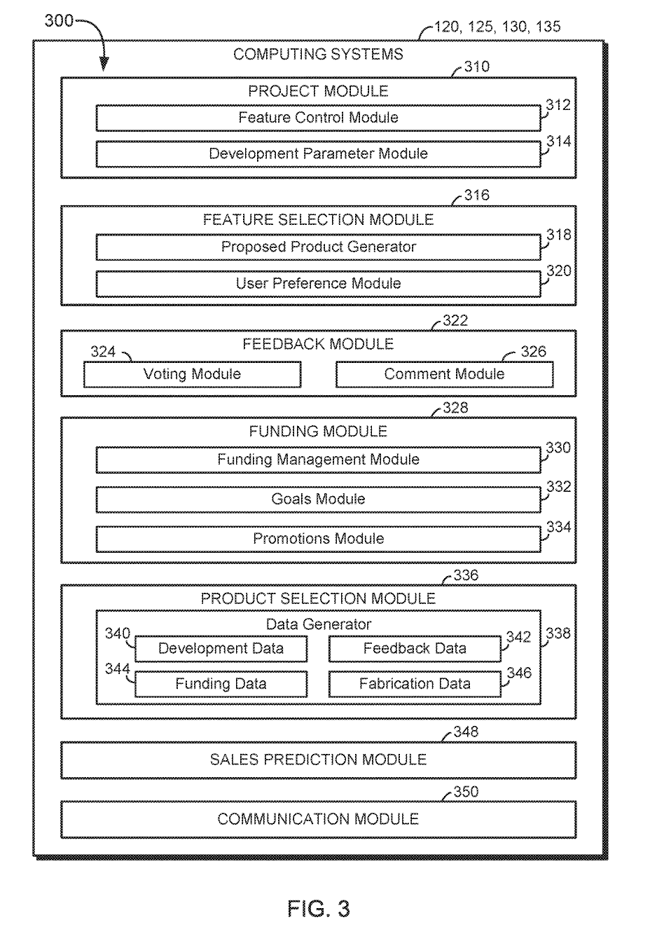

The product or gear developer module 218 is configured to perform the functions described in more detail below with regard to FIG. 3. For example, the gear developer module 218 is configured to provide distributed product development, distributed direct consumer funding, and to provide data (e.g., finished product data and sales prediction parameters) based on those two functions. In the illustrative embodiment, the gear developer module 218 performs portions of the functions of the distributed gear development system 100. While other functions may be performed by the gear developer module 248 on the local computing devices 120, 125, the gear developer module 218 may perform all of the functions on the same computing device.

The user interface 220 includes one or more input devices (e.g., a keyboard, mouse, microphone, touchscreen, etc.) and one or more output devices (e.g., visual displays, LEDs or other indicators, audio speakers, etc.). The user interface 220 is configured to allow a user of the server 130 to access, execute, and manipulate functions performed by the server 130.

The database 222 may be embodied as any type of data storage device, and may include one or more hard drives or other persistent data storage devices (e.g., flash memory, memory cards, etc.). The database 222 is configured to store any and all data produced by the distributed gear development system 100. For example, the database 222 may store project data, user preference data, proposed product data, final product data, feedback data, development data, funding data, fabrication data, and/or sales prediction parameters. In some embodiments, the database 222 is integrated as part of the server 130. In other embodiments, the database 222 may be separate from the server 130 and may be accessed via the network 140. The database 222 may be an embodiment of the gear development database 155. In some embodiments, the database 222 may execute or use the exemplary database schema attached to this patent application as Exhibit A, which is incorporated in its entirety by this reference.

The communication circuitry 224 may communicatively couple the server 130 to other computing devices, databases, and/or systems by through a wired or wireless connection 145. The communication circuitry 224 is configured to transmit and receive information to and from the server 130 using any typical communication protocol, for example, Wi-Fi, Wi-Max, cellular, LTE, Ethernet, BlueTooth, Internet Protocol, or any other type of communication protocol. Accordingly, the communication circuitry 224 may include one or more optical, wired and/or wireless network interface subsystems, cards, adapters, a telephony subsystem, or a radio frequency transceiver and other associated hardware (e.g., amplifiers). The communication circuitry 224 may be embodied as a modem configured to modulate packets and provide the modulated packets to other devices through the network 140. The communication circuitry 224 may also enable shorter-range wireless communications using, for example, near-field communication technology.

Referring now to the local computing devices 120, 125 of FIG. 2, the local computing devices 120, 125 may be embodied as any type of device that is capable of performing the functions described herein. For example, the local computing devices 120, 125 may be a desktop computer, a laptop, a tablet, a smartphone, or another type of computing device. The local computing devices 120, 125 may include components similar to those of server 130. For example, the local computing devices 120, 125 may include a processor 240, memory 242, an I/O controller 246, a gear developer module 248, a user interface 250, communication circuitry 252, all connected via one or more busses 254. In general, elements of the local computing devices 120, 125 having the same or similar name as the elements of the server 130 may be embodied similarly, and a full description of those elements is not repeated here. While not specifically shown in FIG. 2, the local computing devices 120, 125 may include other components as needed to perform its functions.

The gear developer module 248 is configured to execute portions of the distributed gear development system 100 on the local computing device 120, 125 to enable either a user 110 or a project creator 115 to utilize the distributed gear development system 100. In the illustrative embodiment, the gear developer module 248 cooperates with the gear developer module 218 to perform the functions described herein. In some embodiments, the gear developer module 248 performs all of the functions described herein.

FIG. 3 shows an embodiment of a computing environment 300 created by the gear developer module 218, 248. As illustrated in FIG. 3, the computing environment 300 may be implemented on the local computing devices 120, 125, the server(s) 130, or any combination thereof. The computing environment 300 includes a project module 310, a feature selection module 316, a feedback module 322, a funding module 328, a product selection module 336, a sales prediction module 348, and a communication module 350.

The project module 310 is configured to receive, store and manage project data. Before any product development takes place, a project creator 115 must create a project in the distributed gear development system 100. The project data includes a list of features that comprise the product development project. For example, the development project may be for a jacket. Using a local computing device 120, 125, a project creator 115 may input project data, which specifies the features of the jacket to be included in the product development project. The project data includes fixed feature data indicative of one or more fixed features of the product under development and optional feature data indicative of one or more optional features of the product under development. The fixed feature data is indicative of one or more fixed features of the product under development that are not changeable by a user 110. For example, if the product under development is a jacket, the fixed features may include material type, thickness and other features. The optional feature data is indicative of one or more optional features of the product under development that are changeable by a user 110. For example, if the product under development is a jacket, the optional features may include the color of the jacket and/or whether the jacket includes a hood. Both the fixed feature data and the optional feature data include pricing data for each feature. The pricing data includes fixed feature pricing data and optional feature pricing data and is indicative of an estimated cost of each individual feature. In some embodiments, a project creator 115 may alter pricing data to ensure that a proposed product has a price typically observed by consumers. For example, optional feature pricing data may indicate that an optional feature costs $7.37, but the project creator may wish to round that cost to $7.50 or $7.25.

The project module 310 includes a feature control module 312 and a development parameter module 314. Before product development may occur, the project creator 115 must determine what features the product under development will include. In some embodiments, the project module 310 may be configured to prompt the project creator 115 to input feature data and the technical specifications of the product. The feature control module 312 is configured to allow the project creator 115 to control which features of the project group are changeable by a user and which are not. The feature control module 312 is also configured to allow the project creator 115 to specify which combinations of features are permissible. For example, if the project group was devoted to a jacket, an outer layer of the jacket cannot be made of both fleece and leather. While only one example of rules governing optional features is described, it should be appreciated that many other types of rules governing which features are selectable by a user 110 may be implemented using the feature control module 312.

The development parameter module 314 is configured to allow a project creator 115 to set any number of other parameters of the project. For example, project parameters may include the type of product being developed, the funding goals for the project, how long the project development process will remain open, the pricing promotions for the project, the voting rules for the project, and/or any other type of parameter for the project. The development parameter module 314 may also be configured to receive other data associated with the project, such as images of the product under development or images of features of the proposed product under development. These images will be used, and in some cases layered to present an image of a proposed product to the user 110 during the development process.

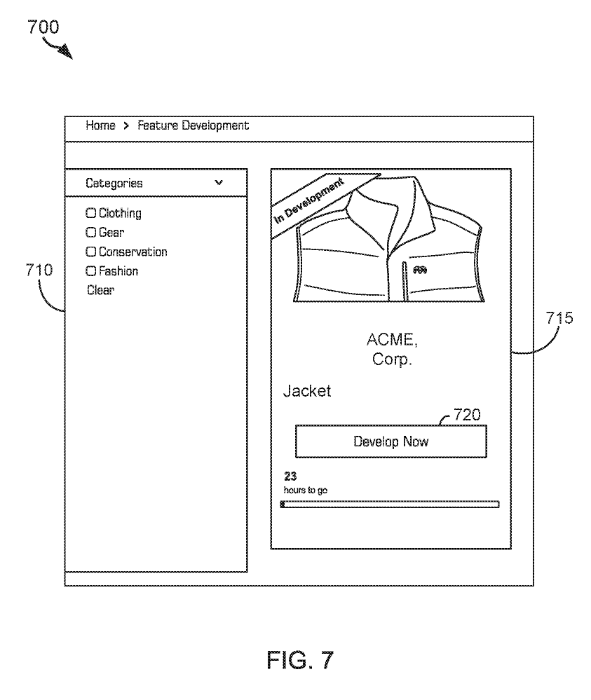

The distributed gear development system 100 permits more than one project to be developed at a time. Users 110 are able to search for and develop particular products they are interested in. Referring to FIG. 7, a graphical representation 700 of selecting a project from a plurality of projects is shown. The graphical representation 700 includes a projects menu 710 and a project overview field 715. In the illustrative embodiment, the projects menu 710 is configured to allow a user 110 to browse various projects by category. The illustrative project overview field 715 gives the user 110 information about the project such as, for example, the title of the project, the creator of the project, and how much time is left to participate in the project. Using button 720 a user 110 may begin generating a proposed product based on the project parameters and the project data.

The feature selection module 316 is configured to allow a user 110 to select one or more optional features of the project and generate a proposed product. The feature selection module 316 includes a proposed product generator 318 and a user preference module 320.

The proposed product generator 318 is configured to generate proposed product data and output the proposed product data to the user 110, generally using the user interface 250 of a local computing device 120, 125. The proposed product data is indicative of the a proposed product built by the user 110 based on the project data and comprises fixed feature data and a subset of the optional feature data indicated by the user preference data. The proposed product data is combination of the project data and the user preference data. Initially, the proposed product generator 318 outputs a generic proposed product to the user 110. The generic proposed product may include the fixed features of the product under development and whatever optional features the project creator 115 has determined to be default optional features.

The user preference module 320 is configured to receive user preference data indicative of the optional features the user 110 may wish to include in the proposed product. In the illustrative embodiment, once the user 110 changes an optional feature (i.e., user preference data is received by the user preference module 320), the proposed product generator 318 generates new proposed product data based on the new user preference data, and outputs a new proposed product to the user 110. In other embodiments, new proposed product data is not generated until the user 110 indicates as such, for example, by pressing an update button.

In the illustrative embodiment, the proposed product generator 318 outputs an image of each proposed product generated. In some embodiments, the image output is an image uploaded by the project creator 115. In other embodiments, the proposed product generator 318 layers one or more images of features together to generate the image of the proposed product. For example, the project creator 115 may upload a picture of a jacket with no hood and a separate image of a hood into a feature image database. If the user 110 selects the optional feature of a hood, the proposed product generator 318 may select the appropriate feature images from the feature image database and layer the jacket image with the hood image to produce the image of the proposed product. In yet other embodiments, the proposed product generator 318 generates an image of the proposed product using other image creation techniques. For example, if the user 110 changes the color of the proposed product, the proposed product generator 318 may be configured to generate a new image of the proposed product with a different color without using a separate image. It should be appreciated that not all features of a proposed product may be readily visible to a customer in the final product. For example, the type of insulation for a coat is obscured from visual inspection by the outer shell of the coat. In another example, internal hardware components such as processors are generally not part of a visual presentation of a finished product. In some embodiments, the image output to the user only shows features (both fixed and optional) which are visually discernible by a user in a finished product. In such embodiments, features that are not discernible by the user in the finished product are not included in the image.

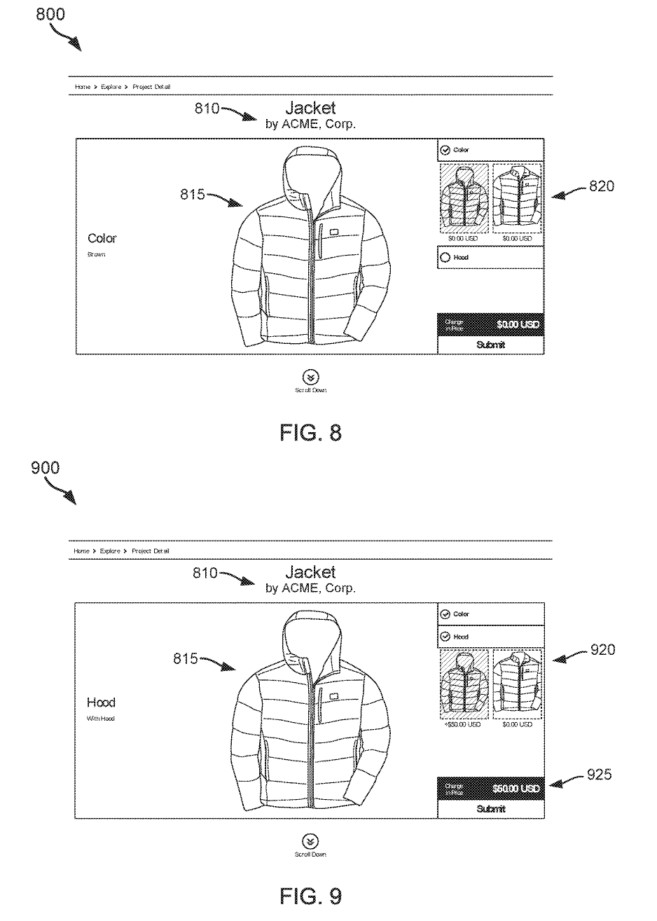

An example of the feature selection process implemented by the feature selection module 316 is shown in FIGS. 8 and 9, which both show graphical representations of a product development process done by a user 110. The illustrative product development process shown by FIGS. 8 and 9 is done by way of example and other products and features may be used with the distributed gear development system 100. In the example, the product under development is a jacket having two optional features, color and a hood. FIG. 8 shows a graphical representation 800 of selecting the illustrative first optional feature, color. The graphical representation 800 includes a title 810 of the project, an image of the proposed product 815, and includes an optional features menu 820 to select the first optional feature. FIG. 9 shows a graphical representation 900 of selecting the illustrative second optional feature, the hood. The graphical representation 900 includes the title 810, the image of the proposed product 815, and includes an optional features menu 920 to select the second optional feature.

Once a user 110 is satisfied with the proposed product being developed, the user 110 submits the proposed product for review by the plurality of other users 110 of the distributed gear development system 100. The crowd sourcing of the distributed gear development system 100 includes this review, voting, and comment period to help determine which proposed product in the project will be best received by consumers at large. The feature selection module 316 is not a purchasing module, but rather is a potential product. For each given project only a handful of proposed products will likely be fabricated or turned into a finished product.

Returning to FIG. 3, the feedback module 322 is configured to allow each user 110 to comment and/or vote on each unique proposed product developed by any of the users 110. In some embodiments, the feedback module 322 groups proposed products into unique proposed products. Meaning, if two users 110 generate identical proposed products, the feedback module 322 will output one example of the unique proposed product for feedback. Each unique proposed product has different proposed product data than the other unique proposed products in the project. Each unique proposed product includes a combination of optional features that is unique from the combinations of optional features of the other unique proposed products. Grouping proposed products into unique proposed products may include comparing the proposed product data against a database of stored proposed product data and determining whether the proposed product data is already stored on the database. The feedback module 322 includes a voting module 324 and a comment module 326.

The voting module 324 is configured to allow the plurality of users 110 to vote on which proposed product they would like to see produced. Typically, if a user 110 developed their own proposed product, that is the proposed product they would normally vote for, but the voting module 324 allows other users (e.g., those who did not develop a proposed product in the project) to vote. In this way, the project creators 115 are able to generate more consumer demand data than typically would be available through only the development process. In some embodiments, the voting module 324 includes a social media component. The social media component allows users 110 to share their proposed products with others and to generate interest in their proposed product or the project as a whole. Because the users 110 become part of the development process, they begin to have an interest to ensure that the project results in a finished product, and more particularly that the finished product is their proposed design. Using the social media component of the voting module 324, a user 110 may generate more votes for a particular proposed project.

The comment module 326 is configured to create a forum of discussion between the plurality of users 110 and the project creators 115 of a particular project. In general, the users 110 who choose to develop and vote on proposed products in any given project will tend to have some interest in the project. For example, outdoor or hunting enthusiasts would be more likely to develop proposed outdoor products than home décor projects. The users 110 of a project may represent a group of enthusiasts who want to see the product produced. As such, the users 110 will likely have feedback for the project creators 115 about features they did not include in the project or other combinations of features. In some instances, the users 110 may have ideas for features and products not initially contemplated by the project creators 115. Project creators 115 and businesses at large do not always fully appreciate all of the problems faced by their consumers and what solutions their consumers desire. The comment module 326 provides a forum from users 110 (i.e., consumers) and project creators (i.e., businesses) to exchange ideas about particular projects and potential future projects. In this way, businesses can more quickly and readily develop new products that consumers will purchase and consumers will have the ability to present valuable product solutions to the businesses.

The funding module 328 is configured to manage the conditional funding received from users 110 after developing a product. After a user 110 develops a proposed product, the user 110 may be prompted to “pre-purchase” the proposed product at given price. However this “pre-purchase” is conditional on the proposed product being selected to be produced. As such the funding module 328 is configured to manage the conditional funds received as part of the “pre-purchase” and will manage project wide funding data as well. The funding module generates funding data which may include conditional funding data indicative of conditional funds received from users 110 to purchase one or more proposed products and project funding data which manages project funding goals and promotions. The funding module 328 includes a funding management module 330, a goals module 332, and promotions module 334. In some embodiments, other users 110 may pre-purchase proposed products that they did not develop themselves.

The funding management module 330 is configured to handle the conditional funds received from the user 110. Initially, there is no guarantee that any proposed product will be produced; however, a user 110 may wish to support their proposed product with money to help ensure that it gets produced. Such pledges of conditional funding help businesses to mitigate the risk of developing a new project and they help businesses better judge the potential demand for a proposed product. The conditional funding is a form of crowd-funding. Many consumers will initially state they are interested in a concept or an idea, but in the end never purchase any product that embodies that concept or idea. In some embodiments, the funding management module 330 receives the conditional funds from the user 110 directly, generates funding data indicative of those funds, and places those funds in an escrow account for the user 110. In other embodiments, a third-party money management system facilitates the conditional funding transaction between the user 110 and the project creators 115. In such an embodiment, the funding management module 330 will generate funding data indicative of the amount of conditional funding, the user 110, the project, and the proposed product and will redirect the user 110 to the third-party. The third-party will then receive the conditional funding and place those conditional funds into an escrow account. In either embodiment, if the proposed design is not selected, the conditional funds are returned to the user 110. If the proposed designed is selected to be produced into a finished product, the conditional funds are released to the project creators 115, the product is then produced and delivered to the user 110.

In some embodiments, the product development stage and the funding stage of a project are separate. In such embodiments, the system 100 may select which proposed product to produce prior to accepting any conditional funds for a proposed product. Once a proposed product is selected, the selected proposed product is moved to the funding stage where the system 100 will accept conditional funding for a pre-purchase of the proposed product. If the proposed product does not meet the funding goals of the project, the proposed product will not be produced and all conditional funding is returned to the providers of the conditional funding.

The “pre-purchase” price or the amount required in conditional funding may be determined based on the pricing data included in the fixed feature data and the optional feature data. The cost of the proposed product may be the sum of a cost of each fixed feature and a cost of the one or more optional features included in the user preference data. As a user 110 adds optional features to a proposed product it may increase the cost to produce the product based on source material costs and/or increased difficulties in fabricating. As shown in FIG. 9, the price field 925 represents a change in price to the proposed product based on the addition of a hood to the jacket. In some embodiments, the user 110 can directly invest in the project to ensure that it will get produced. This can be done through a donation or in light of some other consideration, such as in exchange a share of future profits of the finished product.

Returning to FIG. 3, the goals module 332 is configured to track the funding and development goals of the project as a whole. Often time, project creators 115 understand the economics of manufacturing and may need so many units sold before they will consider producing a product. In such an event, the project creators 115 may wish to show that funding goal to the users 110 and developers of the product. Those interested in receiving a finished product will then be motivated to generate interest in the product, in the form of “pre-purchases” or conditional funding, to ensure the project results in a finished product 150. In some embodiments, the funding goal is related to how much money a producer of goods needs to make a profitable production run of the proposed product.

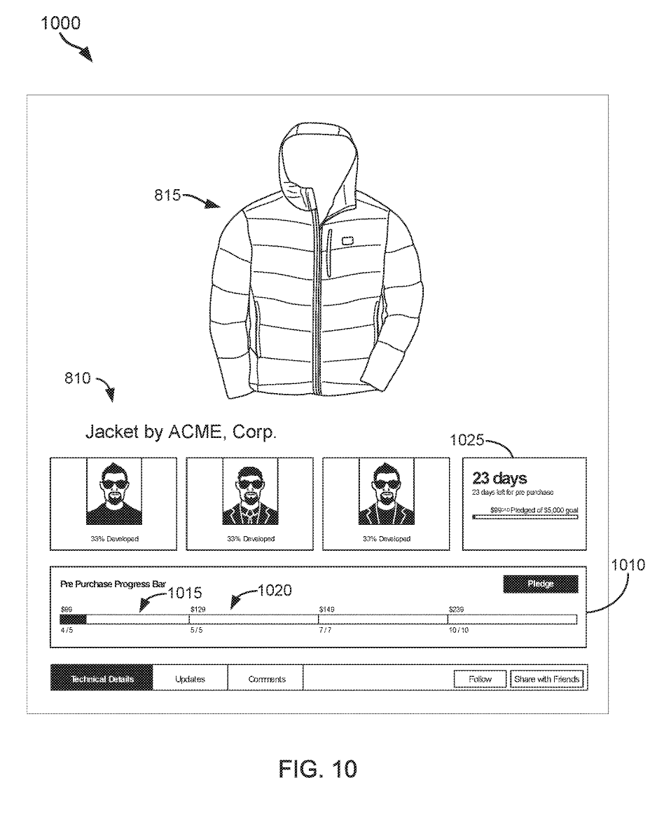

The promotions module 334 is configured to manage any promotions related to the pre-purchase price of a proposed product. Such promotions may be used to incentivize users 110 to purchase during a certain time frame and receive a more favorable price. Or such promotions may be used to incentivize users 110 to generate more pre-purchases for their product. In the illustrative embodiment, the price of earlier “pre-purchases” is less than later “pre-purchases” in order to incentivize users 110 to provide conditional funding now rather than later. For example, FIG. 10 shows a graphical representation 1000 of a funding summary page of a project. The funding page includes a pre-purchase progress bar 1010 indicating how many pre-purchases of a proposed product have been made. The pre-purchase funding bar includes a first section 1015 indicating that a pre-purchase price for the first five purchasers is $99 dollars and a second section 1020 indicating that the pre-purchase price for the next five purchasers is $129. The graphical representation 1000 also includes a status box 1025 indicating the number of development days left in the project and the ultimate funding goal of the project.

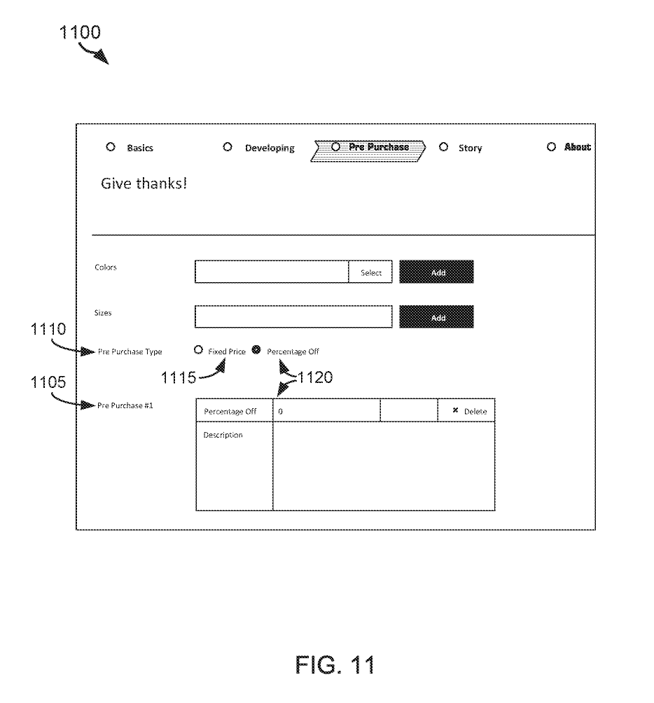

In another example, FIG. 11 shows a graphical representation 1100 of a project development page output to a project creator 115. In some embodiments, pre-purchase prices and promotions may be set by dividing the pre-purchase price into a number of pre-purchase groups 1105. A project creator 115 may select a pre-purchase promotion type 1110 for each pre-purchase group 1105. For example, a project creator 115 may select the percentage off field 1115 to give the first 100 purchasers 25% off of the full pre-purchase price (i.e., a percentage discount). Or, a project creator 115 may select the fixed price field 1120 to give the first 100 purchasers a five dollar discount off of the full pre-purchase price (i.e., a fixed price discount). In some embodiments, a project creator 115 may independently select a promotion type and a promotion level for each pre-purchase group 1105. Pre-purchase groups 1105 may also be determined by a project creator 115. In some embodiments, other types of promotions may be offered by the project creators such as, for example, offering a custom-made order, a behind-the-scenes tour, or handwritten thank you note.

Returning to FIG. 3, the product selection module 336 is configured to determine which of the proposed products in a project should be produced, turned into a finished product 150, and sold to consumers. The product selection module 336 generates finished product data based at least in part on the proposed product data of the selected proposed product. The product selection module 336 may select any number of proposed products to produce, including determining not to produce any of the proposed products. For example, if interest in the project is low, voter turnout is low, or the conditional funding is deemed to be too low, the product selection module 336 may determine that the project should be canceled and no finished product produced.

The product selection module includes a data generator 338 to generate data to aid in the selection process. For example, the data generator 338 may generate development data 340 indicative of parameter of the product development process, feedback data 342 indicative of the preferences of the plurality of users after review the plurality of proposed products developed from the project, funding data 344 indicative of the conditional funding pledged to the proposed products, and fabrication data 346 indicative other data directly related to the fabricators of any finished product. In some embodiments, the selection of proposed products to fabricate is done using data generated by the product selection module 336. In other embodiments, the selection of proposed products to fabricate is done using input from the project creators 115. In yet other embodiments, the selection of products to fabricate is done using a combination of data and input from the project creators 115. The development data 340, the feedback data 342, and the funding data 344 may also include other analytic data such as, for example, the number of site visits, the number of views for each proposed product in all phases of development (development, voting, and funding), time on spent on the page, or other application based metrics or analytic data that may be collected.

The development data 340 may be may be generated from user preference data and may be as simple as the number of users 110 who developed a proposed product and which optional features were selected most frequently. The development data 340 may also include an overall look at the development. For example, the development data 340 may include a development time parameter indicative of the amount of time users 110 took to develop proposed products, or the amount of time the plurality of users took considering individual optional features. Another aspect of development data may be convergence data indicative of how frequently proposed products converged on the same design. For example, if a jacket is being developed and the jacket has two optional features, color and whether it includes a hood. If each optional feature includes two options, then the total possibilities of unique proposed products of the jacket is four. The convergence data determines how many proposed products were developed for each unique proposed product. Furthermore, the convergence data may be more granular and take into account individual features. In such a case, the convergence data may be indicative of what percentage of proposed designs included an optional feature.

The feedback data 342 may be generated from user feedback data received from the users 110 and may include voting data and comment data. The feedback data 342 may be as simple as tallying the number of votes for each proposed product and tallying the number of comments for each product. The feedback data 342 may include a feedback time parameter indicative of how long each user reviewed each proposed product. In some embodiments, the feedback data 342 includes a viral coefficient indicative of the amount of “buzz” the proposed product received. The viral coefficient may include the amounts of shares or likes generated on social media websites or other content sharing platforms.

The funding data 344 may be generated from conditional funding data received from the users 110. The funding data 344 may be as simple as totaling how much conditional funding has been received for each proposed product. The funding data 344 may also include data indicating whether additional pledges of money that are not “pre-purchases” of the proposed product, a time parameter that indicates how fast a proposed product reached its funding goals, or a profit margin associated with the proposed product.

The fabrication data 346 is indicative of one or more other factors that may aid in determining which product to select. For example, fabrication data 346 may include determinations of how much mass-market appeal a proposed product will likely generate (i.e., is the proposed product a niche product for focused group of consumers), likelihood of price fluctuations for certain materials that may affect future costs of production, a predicted profit margin of the proposed product. It should be appreciated that the fabrication data 346 may include other data that the manufacturer deems relevant to the project.

The sales prediction module 348 is configured to generate a sales prediction parameter based at least in part on the data discussed above. The sales prediction parameter is indicative of a prediction of future sales for each proposed product in the project. Each sales prediction parameter may be based at least in part on the development data, the feedback data, the funding data, and the fabrication data. In some embodiments, the sales prediction parameter includes a mass-production prediction parameter indicative of likely future sales if the proposed product were mass-produced and sold in stores and a direct-to-consumer prediction parameter indicative of likely future sales if the proposed product was sold directly to users (e.g., via the Internet). Not all products have the same appeal to consumers. Some products are targeted toward a niche market of specialized consumers. Other products have a general appeal to many consumers. The mass-production prediction parameter and the direct-to-consumer prediction parameter are generated using different algorithms. For example, the mass-production prediction algorithm may more heavily rely on feedback data from users 110 who did not develop a proposed product and a viral coefficient in an effort to determine how much outside attention the product is receiving. Because users 110 of the system 100 are more likely to be enthusiasts, and hence specialists in their market, the direct-to-consumer prediction algorithm may more heavily rely on development data to generate the direct-to-consumer prediction parameter. It should be appreciated that other weighting factors for the different sales prediction parameters are also contemplated by this disclosure.

Once the sales prediction parameter is generated, the sales prediction module 348 may also generate a recommendation how to sell a proposed product. In some embodiments, the sales prediction parameter may indicate that the project should be canceled and that no proposed products should be fabricated. The sales prediction parameter may also be based on other data such as whether a product under development would appeal to a broad consumer base or a narrow consumer base. In some embodiments, the sales prediction parameter may be generated prior to selecting which proposed product to fabricate and may be used as part of the selection process. In other embodiments, the sales prediction parameter is generated as part of post-processing of the project and is used to guide additional endeavors such as whether to mass-market the product after the initial product production or what new projects should be contemplated.

The communication module 350 is configured to communicate the data discussed above between the different computing systems of the distributed gear development system (e.g., the local computing devices 120, 125, the server(s) 130, or the fabrication system 135). The communication module 350 utilizes any of the communication protocols discussed above to send the any of the data across the network 140 using one or more network connections 145.

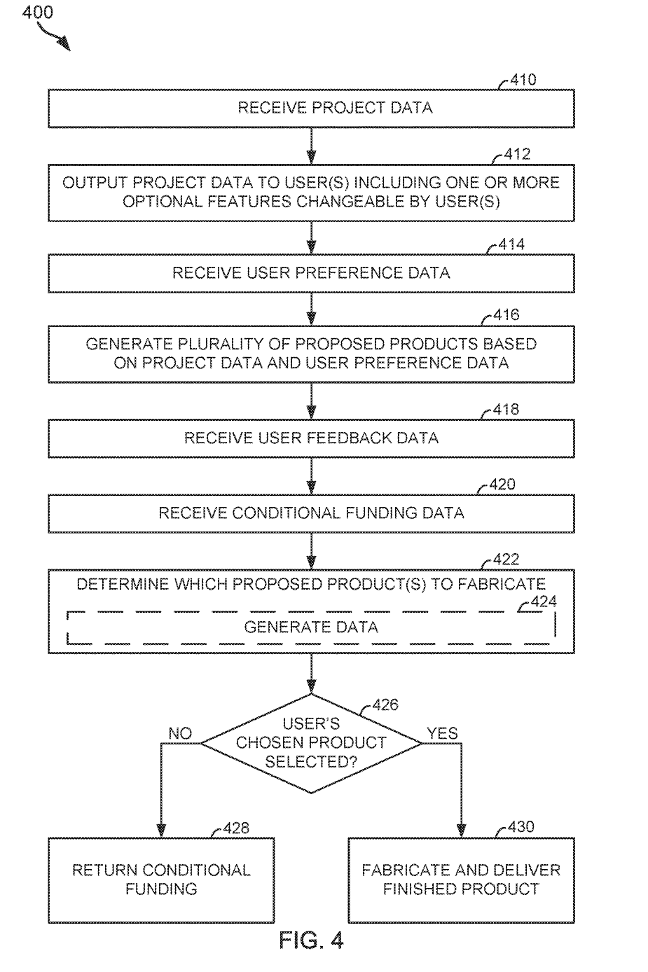

FIG. 4 shows a simplified flow diagram of an illustrative method 400 of developing gear using the distributed gear development and funding system of FIG. 1. The method 400 relates more specifically to a lifecycle of the project from creation to completion of a finished product 150. The method 400 may be embodied as computerized programs, routines, logic and/or instructions that are executed by the computing systems (e.g., local computing devices 120, 125, or server 130).

At block 410, the system 100 receives outputting project data indicative of a product under development to a user 110. The project data comprises fixed feature data indicative of one of more fixed features of the product under development that are not changeable by the user and optional feature data indicative of one or more optional features of the product under development that are changeable by the user. The project data may also include other project parameters such as funding goals and project deadlines. In the illustrative embodiment, the project data is entered into the system 100 by one or project creators 115 using local computing devices 120, 125. The project creators 115 may represent a business seeking feedback on a particular products they are considering producing and selling to consumers.

Once the project data is entered, at block 412, the system 100 outputs the project data to one or more users 110 who indicate they wish to develop a proposed product. As shown in FIG. 7, a user 110 may browse multiple projects before selecting which project (or projects) to begin developing products in. As part of outputting project data to the users 110, the system 100 outputs the technical specifications of a proposed product and indicates which features of the product under development are optional features, meaning the features may be changed by the user 110 (e.g., see FIGS. 8 and 9). In some embodiments, the system 100 outputs an image of the proposed product to the user. Initially, the proposed product seen by the user 110 is a default proposed product set by the project creator 115.

At block 414, the system 100 receives user preference data from the user 110 of the system 100. The user 110 enters the user preference data into the system 100 using a user interface of a local computing device 120, 125.

At block 416, the system 100 generates a plurality of proposed products based at least in part on the project data and the user preference data. For every user 110 that participates in the development stage of the project, the system 100 generates a proposed product based on preferences for optional features the user 110 indicated in the user preference data. For each proposed product, the system 100 also generates proposed product data which is indicative of the unique combination of optional features that make of the specific proposed product. In some embodiments, the system 100 generates an image of the proposed product to visually show what the product would look like with the various optional features. The image of the proposed product may be updated immediately after the system 100 receives the user preference data. The image may be generated by layering one or more images of features (both fixed and optional) features generate the image of the proposed product. Once the user 110 is satisfied with the proposed product, the user 110 submits the proposed product for review.

At block 418, the system 100 receives user feedback data from a plurality of users 110 using the system 100. From the user feedback data, the system 100 generates the feedback data is indicative of the preferences of a plurality of users for the proposed product in question. User feedback data may include a vote entered by a user 110 for a particular proposed product and comments about the proposed product. The feedback data may be used to determine consumer interest in a particular proposed design. In some embodiments, the comment data may indicate new products, new features, or different combinations of features that should be included in future products. In some embodiments, the user feedback data may include feedback from other consumers that are not using the system 100 to develop proposed products, but instead are commenting or voting on proposed designs from the project using a different platform such as, for example, Facebook or YouTube.

At block 420, the system 100 receives conditional funding data from users 110 of the system 100. The conditional funding pledged by a user 110 may be a “pre-purchase” of the proposed product. The fixed feature data and the optional feature data include pricing data for each feature of a proposed product. Proposed products in the same project may fluctuate in price based at least in part on which optional features are selected. In some embodiments, the user 110 may pledge conditional funding independent from a “pre-purchase” price. The conditional funding is a form of crowd-funding and helps a business to offset the financial costs researching and developing a new product.

At block 422, the system 100 determines which proposed product, or which proposed products, to fabricate and turn into finished products 150. The purpose of each project is to determine which combination of features would most likely be purchased by consumers. In some embodiments, the system 100 optionally generates data based on the engagement of the users 110 with the system 100. For example, the system 100 may generate development data 340, feedback data 342, funding data 344, and fabrication data 346. In some embodiments, the system 100 selects which proposed products to produce without any input from the project creators 115. In other embodiments, the project creators 115 interface with the data generated by the system 100. After one or more proposed products are selected, the system 100 generates final product data and transmits that final product data to the fabrication system 135, which produces the finished product 150.

At block 424, the system 100 determines whether a particular user's chosen product was selected to be fabricated. The conditional funding received from users 110 for each proposed product is conditional on whether the proposed product becomes a finished product 150. If the user's paid for proposed product is not selected, at block 426, the system 100 returns the conditional funding to the user 110. If the user's chosen product is selected, at block 428, the system 100 releases the conditional funds to the project creators 115 and the chosen product is fabricated and delivered to the user 110.

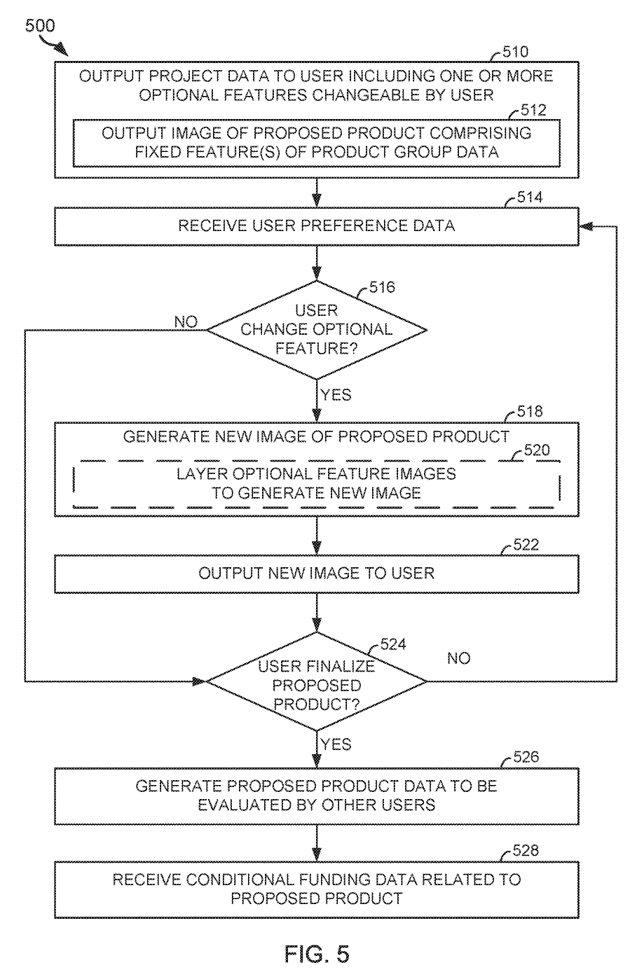

FIG. 5 shows a simplified flow diagram of an illustrative method 500 of generating a proposed product as part of a project and outputting images of the proposed product using the system 100. The method 500 relates more specifically to the development process of a single proposed product in a project. The method 500 may be embodied as computerized programs, routines, logic and/or instructions that are executed by the computing systems (e.g., local computing devices 120, 125, or server 130).

At block 510, the system 100 outputs project data to a user 110 who has opted to develop a proposed product as part of a project. Outputting the project data includes outputting the technical specifications of the product under development. The project data may include fixed feature data indicative of one or more fixed features the user 110 cannot change and optional feature data indicative of one or more optional features the user 110 is able to change. As part of outputting the product data, at block 512, the system 100 outputs to the user an image of the proposed product that comprises the fixed features of the product development and any optional features that the project creator 115 has indicated as default optional features.

At block 514, the system 100 receives user preference data from the user 110 indicative of one or more optional features the user 110 desires to include in the proposed product. At block 516, the system 100 determines whether the user preference data indicates that the user changed an optional feature of the product of under development. If the system 100 determines that the no optional features have been changed, the method 500 moves to block 524 and determines whether the user 110 has finalized the proposed product. If the system 100 determines that an optional feature has been changed, the method 500 moves to block 518.

At block 518, the system 100 generates a new image of the new proposed product indicated by the user preference data. In some embodiments, at block 520, the new image of the proposed product is generated by layering multiple images together. For example, project creators 115 may upload images of each feature into the system 100. The system 100 may layer the individual images of features to generate an image of the proposed product developed by the user 110. At block 522, the new image of the proposed product is output to the user 110 along with the new proposed product data.

At block 524, the system 100 determines whether the user 110 has finalized the proposed product and is done with the development process. If the proposed product is not complete, the method 500 returns to block 514 and repeats blocks 514, 516, 518, 520, 522. If the proposed product is complete, the method 500 moves to block 526 where the system generates proposed product data to be evaluated by other users 110. For example, the system 100 may produce proposed product data, including images of the proposed product, to output to other users as part of the voting and comment process. At block 528, the system 100 receives conditional funding data from the user as part of a pre-purchase of the proposed product. The conditional funding being conditional on the proposed product being turned into a finished product. In some embodiments, users 110 who did not generate the proposed product themselves may still provide conditional funding to pre-purchase the proposed product.

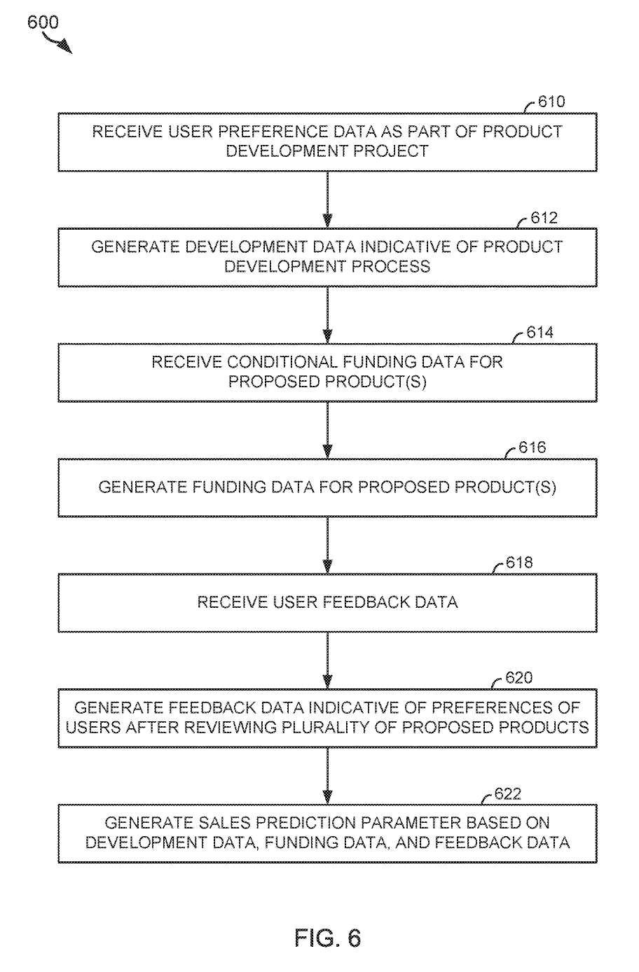

FIG. 6 shows a simplified flow diagram of an illustrative method 600 of generating sales prediction parameters. The method 600 may be embodied as computerized programs, routines, logic and/or instructions that are executed by the computing systems (e.g., local computing devices 120, 125, or server 130).

As part of a product development process, the system 100 may be configured to generate additional data based at least in part on one or more inputs received from the users 110. At block 610, the system 100 receives user preference data as part of the product development project. At block 612, the system 100 generates development data indicative of product development process based at least in part on user preference data. The development data is based at least in part on the user preference data received from the user 110. During the product development process other data related to user preference data may be gathered. For example, a time parameter may track how long a user took to develop an entire proposed product or how long users spent considering individual features. The development data may also include overall data gathered from multiple product development processes. For example, the development data may indicate what individual optional features were most popular among users 110. While a few examples of development data have been discussed, it should be appreciated that development data may include other averages and other types of data that can be gleaned from the development process.

At block 614, the system 100 receives conditional funding data indicative of a pre-purchase of the proposed product. At block 616, the system 100 generates funding data based at least in part on the conditional funding data. The funding data may include information about whether a proposed product has reached its funding goal, promotions about conditional funding pricing, and how long it took to reach funding thresholds. While a few examples of funding data have been discussed, it should be appreciated that the funding data may include other averages and other types of data that can be gleaned from the funding process.

At block 618, the system 100 receives user feedback data from the users 110. At block 620, the system 100 generates feedback data based at least in part on the user feedback data. The feedback data may include the viral coefficient and other data indicating which proposed products have the most comments. While a few examples of feedback data have been discussed, it should be appreciated that the feedback data may include other averages and other types of data that can be gleaned from the feedback process.

At block 622, the system 100 generates a sales prediction parameter based at least in part on the development data, the feedback data, and the funding data. In some embodiments, the sales prediction parameter is also based on other data such as fabrication data. The sales prediction parameter is indicative of a predicted consumer interest in a proposed product. Using the predicted consumer interest, the sales prediction parameter indicates whether a proposed product would be suited for a mass-production and mass-distribution or for more direct-to-consumer models of production and selling. In some embodiments, the sales prediction parameter may indicate that the proposed product should not be produced and sold.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method of distributed product development, the method comprising:
outputting project data indicative of a product under development to a user, the project data comprising fixed feature data indicative of one or more fixed features of the product under development that are not changeable by the user and optional feature data indicative of one or more optional features of the product under development that are changeable by the user;
receiving user preference data indicative of one or more optional features to include in a proposed product;
generating proposed product data based at least in part on the project data and the user preference data, the proposed product data comprising the fixed feature data and a subset of the optional feature data indicated by the user preference data;
generating an image of the proposed product based at least in part on the proposed product data, the image showing the features of the proposed product including the fixed features and the one or more optional features included in the user preference data; and
outputting the image to the user.

2. The method of claim 1, wherein generating the image further comprises layering one or more feature images together.

3. The method of claim 2, further comprising selecting the one or more feature images from a feature image database based at least in part on the proposed product data.

4. The method of claim 1, wherein the image is generated immediately upon receiving user preference data.

5. The method of claim 1, further comprising determining that the proposed product is ready to be reviewed by other users.

6. The method of claim 5, further comprising:
outputting the image to the plurality of users prior to receiving user feedback data, and
receiving a plurality of votes from the plurality of users, the votes being used to determine which proposed product of the project will be produced.

7. The method of claim 1, further comprising determining whether the proposed product will be produced based at least in part on feedback data received from a plurality of users.

8. The method of claim 1, further comprising receiving conditional funding data indicative of conditional funding received for producing the proposed product, wherein the conditional funding is returned to the user if the proposed product is not produced.

9. The method of claim 1, wherein the image shows fixed features and optional features that are visually apparent to the user in a final product.

10. A method of distributed product development, the method comprising:
outputting project data indicative of a product under development to a user, the project data comprising fixed feature data indicative of one or more fixed features of the product under development that are not changeable by the user and optional feature data indicative of one or more optional features of the product under development that are changeable by the user;
receiving user preference data indicative of one or more optional features to include in a proposed product;
generating proposed product data based at least in part on the project data and the user preference data, the proposed product data comprising the fixed feature data and a subset of the optional feature data indicated by the user preference data;
receiving conditional funding data indicative of conditional funding received for producing the proposed product, wherein the conditional funding is returned to the user if the proposed product is not produced; and
determining whether the proposed product will be produced based at least in part on feedback data received from a plurality of users.

11. The method of claim 10, further comprising:
receiving a plurality of proposed products developed from the project data, each of the proposed products having associated proposed product data; and
grouping the plurality of proposed products into unique proposed products, wherein the proposed product data for each unique proposed product is different than the proposed product data for other unique proposed products.

12. The method of claim 11, wherein each unique proposed product includes a combination of optional features that is unique from combinations of optional features of the other unique proposed products.

13. The method of claim 11, wherein grouping the proposed products further comprises:
comparing the proposed product data against a database of stored proposed product data; and
determining whether the proposed product data is already stored on the database.

14. The method of claim 11, further comprising selecting at least one of the proposed products of the plurality of proposed products to produce based at least in part on the feedback data from the plurality of users.

15. The method of claim 14, wherein the feedback data comprises votes for one or more of the plurality of proposed products.

16. The method of claim 10, wherein the conditional funding data further indicates an escrow account that the conditional funding be placed into until it is determined whether the proposed product will be produced.

17. The method of claim 10, wherein the conditional funding is at least equal to a cost of the proposed product, the cost of the proposed product being a sum of a cost of each fixed feature and a cost of the one or more optional features included in the user preference data.

18. The method of claim 10, wherein the project data includes pricing data for each feature of the product under development such that each fixed feature has fixed pricing data and each optional feature has optional pricing data.

19. The method of claim 18, further comprising setting a new proposed price after a time threshold has been surpassed.

20. The method of claim 10, further comprising:
generating an image of the proposed product using the proposed product data; and
outputting the image to the user to allow the user to review one of more optional features selected as part of the user preference data.

21. The method of claim 10, wherein receiving conditional funding data further comprises receiving conditional funding for a proposed product that was generated from a different user's user preference data.

22. The method of claim 10, wherein the project data, the user preference data, the proposed product data, the feedback data, and the funding data are stored on a gear development database.

23. The method of claim 10, wherein the project data includes a funding goal indicative of how much money a project creator requires to produce the proposed product.

24. A method of predicting future sales, the method comprising:
receiving user preference data, user feedback data, and conditional funding data as part of a product development process;
generating (i) development data indicative of the product development process performed by the plurality of users using project data, (ii) feedback data indicative of preferences of the plurality of users after reviewing a plurality of proposed products developed from a project, and (iii) funding data indicative of conditional funding pledged to the proposed products; and
generating a sales prediction parameter indicative of a prediction of future sales for each proposed product of the plurality of proposed products, each sales prediction parameter based at least in part on the development data, the feedback data, and the funding data associated with its respective proposed product.

25. The method of claim 24, further comprising predicting future sales of the proposed product based at least in part on convergence data indicative of how many proposed products converged on a similar set of features, votes cast in favor of producing the proposed product, or a speed with which the proposed product was funded using conditional funding.

26. The method of claim 24, wherein the sales prediction parameter includes a mass-production prediction parameter indicative of likely future sales if the proposed product were mass-produced and sold in stores and a direct-to-consumer prediction parameter indicative of likely future sales if the proposed product were sold directly to users.

27. The method of claim 24, wherein the development data includes proposed product data generated by the plurality of users, convergence data indicative of whether the product development process converged on a few recurring proposed products, a number of times any given proposed product of the plurality of proposed products was generated, or a development time parameter indicative of an amount of time users took to develop proposed products.

28. The method of claim 24, wherein the feedback data includes voting data generated by the plurality of users after reviewing one or more proposed products and comment data received regarding each proposed product.

29. The method of claim 24, wherein the funding data includes an amount of money raised in conditional funding for the proposed product, how fast a project reaches its conditional funding goals, and a profit margin associated with the proposed product.

30. The method of claim 24, wherein the sales prediction parameter is based at least in part on fabrication data.
